(19) United States
(12) Patent Application Publication
(10) Pub. No.: US 2020/0222908 A1
(43) Pub. Date: Jul. 16, 2020

(54) DEVICE AND METHOD FOR SEPARATING MATERIAL COMPOSITES

(71) Applicant: DIEFFENBACHER GMBH Maschinen- und Anlagenbau, Eppingen (DE)

(72) Inventors: Felix HOFMANN, Eppingen (DE); Jochen KAMM, Eppingen (DE)

(21) Appl. No.: 16/604,975

(22) PCT Filed: Apr. 13, 2018
(86) PCT No.: PCT/EP2018/059523

§ 371 Date: Oct. 11, 2019

(30) Foreign Application Priority Data
Apr. 13, 2017 (DE) 10 2017 108 106.2

(51) Int. Cl. B02C 13/14; B02C 13/284; B02C 13/286; B02C 13/288; B02C 23/30

(52) U.S. Cl. CPC B02C 13/14; B02C 13/284; B02C 2013/28609; B02C 13/288; B02C 23/30; B02C 13/286

(57) ABSTRACT

A device for separating material composites to be disposed of, including at least two material fractions with differing material properties, and a method for separating such material composites are provided. The device, in a region of an upper cover plate, has a bowl-shaped dispensing channel having at least one opening facing toward an impact chamber, and a dispenser arranged in the channel and designed to receive material fractions of a second type from the region of the chamber above a first separating screen and/or near the upper cover plate. Individual material fractions of a material composite, such as a material fraction of the second type to be comminuted and having a lower density than a first material fraction, may be separated in larger pieces from remaining material, to facilitate the transport of individual material fractions and further processing as part of raw material recovery.

The present invention relates to a device at least for separating material composites to be disposed of consisting of at least two material fractions which differ with respect to their material properties according to the preamble of Claim 1, and to a method for separating such material composites to be disposed of consisting of at least two types of material fractions which differ with respect to their material properties according to Claim 12.

Within the context of the sustainable use of raw materials, the reclamation of recyclable materials from material composites to be disposed of is playing an increasingly important role. The term “material composite” refers not only to permanent, not easily separable material combinations (e.g. by bonding, gluing, pressing) of two or more material fractions which differ with respect to their material properties, but also to inhomogeneous material accumulations, such as organic waste in not readily decomposable plastic bags.

The comminution of the material composites to be disposed of and separation into the different material fractions is usually the first step in the reclamation of recyclable materials.

A wide variety of comminuting devices have become known for the industrial reclamation of recyclable materials from material to be disposed of. Reference is made here to the comminuting devices described in EP 1 536 892 B1, EP 1 721 674 B1 or WO 2010/057604 A1, for example, each of which comprises a first comminution stage with a striking tool which rotates in a cylindrical housing and to the central region of which a feed channel for the material to be disposed of is led, wherein the striking tool rotates at high speeds, thus generating a high-speed radial air vortex which takes material fractions comminuted by impact in the first comminution stage from openings configured in the cylindrical housing to the discharge of sufficiently comminuted material fractions into a collection chamber. The disadvantage of these comminuting devices known from the state of the art is the fact that the material throughput is limited by the outlet openings in the housing.

To improve the material throughput and in particular to produce dust from the material to be disposed of, DE 10 2015 101 530 A1 of the applicant already discloses a comminuting device for the reclamation of secondary raw materials from disposed of material and a method for controlling said device.

The device and/or method described therein comprises two comminution stages, wherein the passage options, and consequently the throughputs, in the second comminution stage are advantageously increased as a result of the screens arranged on the double-walled housing. The different screen arrangements also make it possible to obtain dusts having different particle size distributions from the material to be disposed of with the described device.

All of the comminuting devices described here focus on a comminution of the material to be disposed of that is as complete as possible, in particular friction-comminuted material fractions and the collection thereof in collection containers as small pieces, in particular in the form of dust.

However, within a reclamation process of recyclable material, it may be advantageous to separate individual material fractions of a material composite from the remaining material in larger pieces; in particular if this can facilitate transport and further processing.

Based on this, the object of the present invention is to provide a device at least for separating material composites to be disposed of consisting of at least two material fractions which differ with respect to their material properties that is improved in comparison to the state of the art, as well as an improved method for separating such material composites, which in particular allows the separation and/or the dispensing of individual material fractions in comparatively large pieces. This object is achieved with a device at least for separating material composites to be disposed of consisting of at least two material fractions which differ with respect to their material properties having the features of Claim 1, and with a method for separating such material composites to be disposed of consisting of at least two types of material fractions which differ with respect to their material properties according to the features Claim 12.

Advantageous configurations and further developments that can used individually or in combination with one another are the subject of the dependent claims.

The invention is generically based on a device at least for separating material composites to be disposed of consisting of at least two types of material fractions which differ with respect to their material properties, having an impact chamber for mechanical comminution, splitting and/or separation of the material composite to be disposed of into at least two types of material fractions, comprising a base plate, at least one side wall and an upper cover plate, a striking tool, which rotates in the impact chamber and comprises striking elements, a feed channel for delivering the material composite to be disposed of to the striking tool, wherein at least one first separating screen for separating material fractions of a first type into a first receiving chamber is disposed in the base plate and/or the side wall, and wherein at least one dispensing device for dispensing material fractions of a second type to a second receiving chamber is disposed above the first separating screen.

The device at least for separating material composites to be disposed of consisting of at least two material fractions which differ with respect to their material properties according to the invention is based on generic devices in that,
at least in sections, the dispensing device in the region above the first separating screen and/or the upper cover plate includes
   a preferably bowl-shaped dispensing channel configured with at least one opening toward the impact chamber and
   a dispensing means, which is disposed in the dispensing channel and
      and is configured to receive material fractions of the second type from the region of the impact chamber above the first separating screen and/or near the upper cover plate.

The dispensing device according to the invention advantageously makes it possible to receive at least one second material fraction of a material composite, preferably the one that is to be comminuted the least, and preferably also has a lower density than the first material fraction, from the region of the impact chamber above the first separating screen near the upper cover plate, in particular “floating,” and dispense it continuously or semicontinuously.

In a preferred embodiment of the invention, the dispensing means arranged in the dispensing channel is configured as a screw conveyor, as a spiral conveyor and/or as a cellular wheel. A dispensing means configured in this way advantageously makes it possible to in particular dispense material fractions of the second type out of the device without further comminuting them during dispensing. A screw conveyor can advantageously have higher axial rigidity and thus greater robustness, in particular during long-term operation. Dispensing means configured as spiral conveyors, on the other hand, have the advantage that, owing to the absence of a screw shaft (a so-called “soulless structure”), they are less likely to be clogged by material that adheres to or catches on the screw shaft and can consequently freely dispense in particular larger, film-like material fractions of the second type. A dispensing means configured as a cellular wheel can advantageously shield the dispensing channel from any material fractions of the first type that are flung up and functions as a sluice for receiving material fractions of the second and third type.

In a further embodiment of the invention, it has proven effective for the dispensing channel between the second receiving chamber and the first bowl-shaped section in the impact chamber to include a longitudinally axial section and/or a transversely axial section. In a longitudinally axial, preferably tubular section or in a transversely axial, preferably polygonal section of the dispensing channel, the material fraction of the second type can advantageously be transported to the second receiving chamber largely without air turbulence.

An embodiment, in which means for completely or partially reversibly closing the opening are provided, has proven effective as well. Means for completely or partially reversibly closing the opening can protect the dispensing channel and/or the dispensing means from damage caused by relatively heavy material fractions of the first type that may be flung up. Furthermore, the quantity of the material inflow can advantageously be controlled, in particular by a partial closing of the opening.

An alternative configuration includes the arrangement of rake-like elements in the upper region of the impact chamber or of other suitable catching bodies that catch the lighter material, preferably at the upper reversal point of the material. To do this, it would be necessary to provide a suitable dispensing device for the lighter material, and/or the catching bodies, or the rake-like elements.

It would also be conceivable to allow the upper opening to become clogged with the lighter material and to intermittently disconnect it from the impact chamber via a valve or slide arrangement to remove the lighter material fraction.

With respect to the height of the impact chamber, it can be provided that the necessary height of the impact chamber is dimensioned in such a way that, similar to the manner of a floating sifter, the lighter material fraction, in particular also the larger material fraction that consequently has greater buoyancy, accumulates in the upper region.

It is also advantageous if a dispensing means configured as a screw conveyor and/or as a spiral conveyor ends in a longitudinally axial, preferably tubular, section, and a dispensing means configured as a cellular wheel ends in a transversely axial, preferably polygonal, section of the dispensing channel. Material fractions of the second type dispensed from the device can advantageously be transported out of the longitudinally axial, preferably tubular, section or out of the transversely axial, preferably polygonal, section of the dispensing channel into the second receiving chamber. For this purpose, the longitudinally axial and the transversely axial section of the dispensing channel can advantageously include conveying means, such as belt conveyors and/or movable rakes, and/or be configured as a chute.

In a further preferred embodiment, it has proven effective to dispose a movable rake for the portioned dispensing of material fractions of the second type into the second receiving chamber between the dispensing means and the second receiving chamber, in particular in the longitudinally or transversely axial sections of the dispensing channel. A rake disposed in this way can advantageously remove pieces of material fractions of the second type, which have fallen out of the dispensing means during dispensing, from the region between the dispensing means and the second receiving chamber, in particular from the longitudinally or transversely axial sections of the dispensing channel, and deliver them to the second receiving chamber. As a result, clogging of these regions by material that accumulates during operation can advantageously be prevented.

An embodiment has furthermore proven effective, in which feed nozzles for delivering fresh air for transporting material fractions of the second type across the striking tool are disposed adjacent to the first separating screens.

The delivery of fresh air via feed nozzles disposed adjacent to the first separating screens can advantageously serve to control the flow velocity of a circulating airflow in the region of the first separating screens, in particular an airflow created by the striking tool. Material fractions of the second type can advantageously be carried into the circulating airflow from the region of the first separating screens and then transported to the region of the impact chamber near the upper cover plate.

It is also advantageous if feed nozzles for delivering fresh air for transporting material fractions of the second type to the upper cover plate, in particular to the dispensing device, are disposed in the side wall. Such feed nozzles for delivering fresh air, which are disposed in the side wall, can advantageously be used for pressure equalization and/or for stabilization, and also for controlling the circulating airflow in the impact chamber. Material fractions of the second type can thus be delivered to the dispensing device in a more targeted manner.

Fresh air is understood to be deliverable recirculating air, or particularly preferably recirculating air from the device that can be taken from the device elsewhere, in particular exhaust air that is suctioned out of the receiving chambers. This has the particular advantage that the exhaust air does not always have to be specially cleaned, and preferably only passes through coarse filters or separators to be cleaned of the respective material fraction.

In a further preferred embodiment of the invention, the base of the bowl-shaped dispensing channel opposite to the opening to the impact chamber is operatively connected with a suction device for the supportive transport of material fractions of the second type into the dispensing means. It has also proven effective for a second separating screen for separating material fractions of a third type into a third receiving chamber to be disposed in the base of the bowl-shaped dispensing channel opposite to the opening to the impact chamber. The suction device can advantageously generate a dispensing airflow that can transport material fractions of the second type to the dispensing means in interaction with the circulating airflow in the impact chamber. Small-pieced, in particular dust-like, material fractions of a third type can also advantageously be removed via the suction device and thus already separated from material fractions of the second type during this procedure. The second separating screen disposed in the base of the bowl-shaped dispensing channel opposite to the opening to the impact chamber can advantageously prevent too large material fractions from being pulled into the suction device and thus in particular prevent clogging of the suction device.

Alternatively, a third type or further types of material fractions can be separated and removed from the material composite.

Lastly, an embodiment of the invention has proven effective, in which the dispensing means is disposed and configured relative to the second separating screen in such a way that material fractions of the second type adhering to the second separating screen are removed by the dispensing means during dispensing. Material fractions of the second type, which adhere to the second separating screen due to the dispensing airflow of the suction device, can thus advantageously be removed from the separating screen by the dispensing means, in particular scraped off, and dispensed from the impact chamber into the second receiving chamber by the dispensing means. Clogging of the second separating screen can thus advantageously be prevented, which can in turn advantageously shorten the system's service and/or cleaning times.

The invention furthermore relates to a method for separating material composites to be disposed of consisting of at least two types of material fractions which differ with respect to their material properties with the aid of a device as described above.

Compared to the generic methods, a method for separating material composites to be disposed of consisting of at least two types of material fractions which differ with respect to their material properties according to the invention is characterized in that
a material composite to be disposed of, which comprises at least two types of material fractions having different material properties,
is comminuted and/or split into material fractions of different types by interaction with striking elements of a striking tool and/or by interaction with at least one side wall of an impact chamber;
a circulating airflow is generated in the impact chamber by a movement of the striking tool and/or by an injection of fresh air via feed nozzles;
the types of material fractions are separated within the impact chamber into at least one material fraction of a first type and at least one material fraction of a second type by the circulating airflow in the impact chamber;
the material fraction of the first type is fed into a first receiving chamber via at least one first separating screen disposed in a base plate and/or a side wall of the impact chamber;
the material fraction of the second type is transported to a dispensing device at least partially by the circulating airflow; and
a dispensing means of the dispensing device receives the material fraction of the second type from the region of the impact chamber above the first separating screen and/or near an upper cover plate and dispenses it from the device through a dispensing channel.

The method according to the invention advantageously makes the separation of material composites to be disposed of consisting of at least two material fractions which differ with respect to their material properties into material fractions of different types possible, wherein the separation of a material fraction of the second type that should at least be comminuted and preferably also has a lower density than a first material fraction can preferably be in relatively large pieces.

In a preferred method step, the material fraction of the second type is transported to the dispensing means of the dispensing device at least partially by a dispensing airflow, which is generated by a suction device that is operatively connected to a base of the bowl-shaped dispensing channel opposite to the opening to the impact chamber. If the material fraction of the second type is transported to the dispensing means of the dispensing device at least partially by a dispensing airflow, the dispensing yield, i.e. the quantity of material fraction of the second type received by the dispensing means from the region of the impact chamber near the upper cover plate and dispensed, can advantageously be increased.

Lastly, a method step is preferred, in which a material fraction of the third type, in particular a dust-like fraction, is separated from the material fractions of the first and/or second type by means of a second separating screen disposed in the base of the bowl-shaped dispensing channel opposite to the opening to the impact chamber, and suctioned out of the device with the aid of a dispensing airflow of a suction device that is operatively connected with a base of the bowl-shaped dispensing channel opposite to the opening to the impact chamber. Preferably a material fraction of a third type, which is lighter than material fractions of the first and second type, in particular a dust-like fraction, and is formed in the course of splitting the material composites into material fractions of different types, can thus advantageously be removed during operation. Contamination of the material fractions of the first and second type can thus advantageously be minimized, which can in particular be important for further processing of the material fractions of the first and/or second type within the context of raw material recycling.

The present invention relates to a device at least for separating material composites to be disposed of consisting of at least two material fractions which differ with respect to their material properties, and to a method for separating such material composites, characterized in that, at least in sections, the dispensing device in the region above the first separating screen and/or the upper cover plate comprises a bowl-shaped dispensing channel having at least one opening facing toward the impact chamber, and a dispensing means, which is arranged in the dispensing channel and is designed to receive material fractions of the second type from the region of the impact chamber above the first separating screen and/or near the upper cover plate. The device according to the invention and the method advantageously allow individual material fractions of a material composite, preferably a material fraction of a second type that should at least be comminuted and preferably also has a lower density than a first material fraction, to be separated in larger pieces from the remaining material, as a result of which the transport of said individual material fractions and the further processing as part of a raw material recovery can be facilitated.

The material fractions of a first, second or third type may also be referred to in the following as first, second and third material fractions.

Further advantages and embodiments of the present invention will be described below with reference to preferred design examples and in conjunction with the drawing. The figures schematically show:

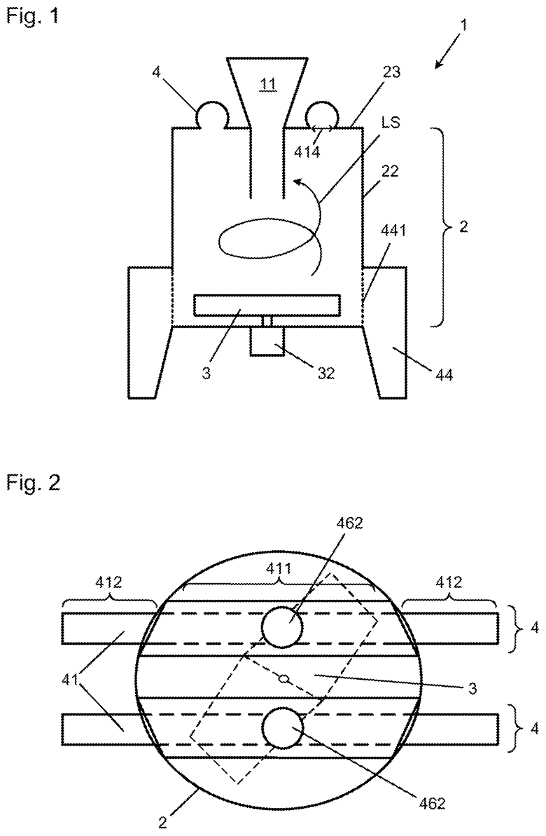

FIG. 1 a first embodiment of a device according to the invention at least for separating material composites to be disposed of consisting of at least two types of material fractions which differ with respect to their material properties in a cross section through the dispensing devices on the cover plate of the impact chamber;

FIG. 2 a plan view onto the device of FIG. 1 with an indication of a view into the impact chamber;

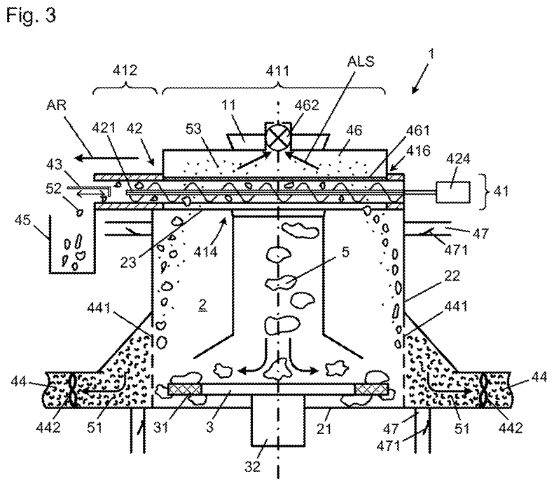

FIG. 3 a device according to the invention as per FIG. 1 in a section along a dispensing device with a dispensing means of the dispensing device configured as a screw conveyor;

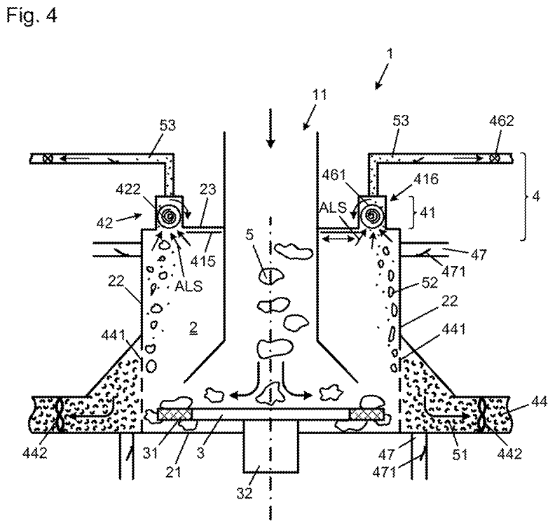

FIG. 4 a second embodiment of the device according to the invention with a dispensing means configured as a spiral conveyor;

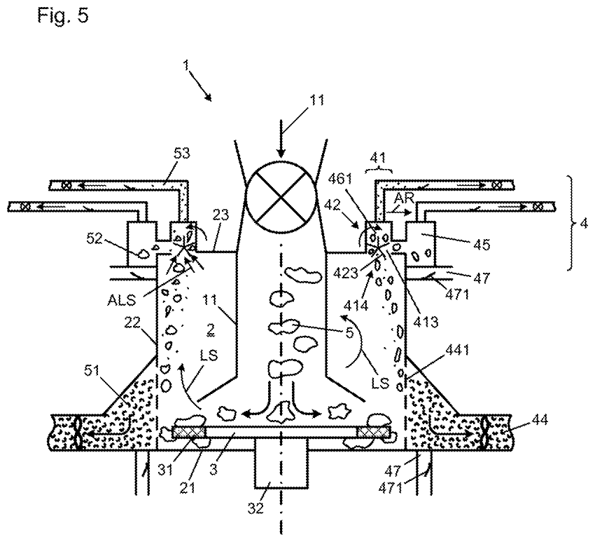

FIG. 5 a third embodiment of a device according to the invention with a dispensing means configured as a cellular wheel again in a section transverse to the dispensing device.

In the following description of preferred embodiments of the present invention, the same reference signs identify the same or comparable components.

FIG. 1 shows a first embodiment of a device according to the invention for separating material composites to be disposed of consisting of at least two types of material fractions which differ with respect to their material properties in a cross section through the dispensing devices 4. The dispensing devices 4 are disposed above the cover plate 23 and, with an opening 414, are operatively connected with the impact chamber 2. The material composite 5 can be delivered to the device 1 or the impact chamber 2 via a feed channel 11. A rotatable striking tool 3 which can be set in rotation by an electric motor 32 is disposed above the base plate 21, which delimits the impact chamber 2 at the bottom. The impact chamber is laterally delimited by a side wall 22, preferably a rotationally symmetrical cylinder. Disposed in the lower region of the impact chamber, in the base plate 21 and/or the side wall 22, is a first separating screen 441, via which a material fraction 51 of the first type can be dispensed. Said fraction thus enters the receiving chamber 44 and can be transported away from there. The rotating striking tool 3 creates superimposed and complex flows in the impact chamber 2, which allow a lighter, preferably large material fraction 52 to accumulate in the upper region of the impact chamber 2 and be removed from the impact chamber 2 via the openings 414 and the dispensing devices 4.

FIG. 2 shows a plan view of the device 1 from FIG. 1 with an indication of a view into an impact chamber 2. A striking tool 3 can be seen, which rotates in the impact chamber 2 and, via the interaction of its striking elements 31 with the material composites 5 to be disposed of, comminutes and/or splits said material composites into material fractions of different types of 51, 52, 53 and, through its movement, also generates a circulating airflow LS in the impact chamber 2. The dispensing devices are seen from above in the plan view, which, along a preferably bowl-shaped, section 411, have an opening 414 facing toward the impact chamber 2 and can transport the second material fraction 52 in the direction of an adjacent section 412 through a not depicted dispensing means. A suction device 462 can be provided to support the intake of the second material fraction 52 by the receiving devices 4. Preferably, a second separating screen 461 [is added], which protects the suction device 462 from too large pieces of the material fraction 52 and, if necessary, serves to dispense a third material fraction 53 that can pass through the second separating screen 461.

FIG. 3 shows the device 1 of FIG. 1 with a dispensing means 42 of the dispensing device 4 configured as a screw conveyor 421. In the region of the upper cover plate 23, at least in sections, the dispensing device 4 comprises a bowl-shaped dispensing channel 41 with at least one opening 414 facing toward the impact chamber 2 and a dispensing means 42, which is disposed in the dispensing channel 41 and is configured to receive material fractions 52 of the second type from the region of the impact chamber 2 near the upper cover plate 23.

Material composites 5 to be disposed of, which consist of at least two types of material fractions 51, 52, 53 having different material properties and are delivered via the feed channel 11 of the device 1, can, by interaction with the striking elements 31 of the striking tool 3 and/or by interaction with at least one side wall 22 of the impact chamber 2, advantageously be split into material fractions 51, 52, 53 of different types, in this case into a heaviest material fraction 51 of the first type, into a material fraction 52 of the second type that is relative lighter than the first material fraction 51 and is in particular film-like, and into a, in particular dust-like, material fraction 53 of the third type that is smaller and/or lighter than the material fractions 51, 52 of the first and second types.

After splitting, the types of material fractions 51, 52, 53 can be separated within the impact chamber 2 into at least one material fraction 51 of a first type and at least one material fraction 52 of a second type or, as shown, into three material fractions 51, 52 and 53 by the circulating airflow LS in the impact chamber 2. Similar to the principle of heavy materials sifting, the circulating airflow LS now transports the relatively lighter material fractions 52, 53 of the second and third types in the impact chamber 2 into the region of the upper cover plate 23. The relatively heavier material fraction of the first type 51, on the other hand, remains in the region of the base plate 21 or sinks back down faster.

At least one first separating screen 441 for separating material fractions 51 of the first type into a first receiving chamber 44 is disposed in the base plate 21 and/or, as shown here, in the side wall 22. A conveying means 442 for removing the material fraction of the first type 51, which can in particular be configured as a suction device, as a belt conveyor and/or as a rake, can preferably be provided in the first receiving chamber 44. The material flow to the conveying means 442 or into the first receiving chamber 44 can be controlled with the aid of the first separating screen 441, which is preferably disposed in the impact chamber 2 at the first receiving chamber 44.

This device is particularly suitable for separating film-like labels, for example, from heavy, preferably more brittle materials. Another excellent application is the treatment of biomass from organic waste recycling in urban communities. This biomass is sometimes disposed of in not or not readily decomposable garbage bags that are not directly suitable for fermentation or composting. The moist and heavy biomass settles in the lower part of the impact chamber and is relatively easily dispensed via the first separating screen 441, whereas the film-like bags are broken up by the airflow and perhaps also by the striking tool, partly cleaned and, due to their large shape, accumulate in the airflow in the upper region of the impact chamber 2.

Feed nozzles 47 for delivering fresh air for transporting material fractions 52 of the second type across the striking tool 3, can advantageously be disposed adjacent to the two first separating screens 441 shown here. In the depicted example, fresh air is delivered via two feed nozzles 47 disposed in the base plate 21, whereby the flow rate and/or flow quantity of the delivered air can preferably be regulated via control valves 471 disposed on the feed nozzles 47. The thus delivered fresh air can advantageously blow material fractions of the second type 52, which have not yet been transported into the region of the upper cover plate 23 by the circulating airflow LS, away from the separating screens 441 or the side wall 22 into the interior of the impact chamber 2, and consequently into the circulating airflow LS. The separation of material fractions 51, 52 of the first and second type can thus advantageously be improved and the stability of the circulating airflow LS can be increased at the same time.

Feed nozzles 47 for delivering fresh air for transporting material fractions 52 of the second type to the upper cover plate 23, in particular to the dispensing device 4, disposed in the side wall 22, can further increase the stabilization of the circulating airflow LS and improve the transport of material fractions 52 of the second type to the dispensing means 42 of the dispensing device 4. The air delivered into the region near the upper cover plate 23 can also advantageously equalize the negative pressure possibly created in the region of the opening 414 of the dispensing channel 41 by a suction device 462.

As can be seen in FIG. 3, the dispensing means 42 which is disposed in the dispensing channel 41 and in this case is the screw conveyor 421, is preferably configured to receive material fractions 52 of the second type from the region of the impact chamber 2 near the upper cover plate 23. It can be advantageous if the dispensing means 42 projects at least partially into the region of the impact chamber 2 near the upper cover plate 23.

Material fractions 52 of the second type, which enter the dispensing channel 41 through the opening 414 of the dispensing device 4, can then be dispensed by the dispensing means 42 disposed therein along a dispensing direction AR into a second receiving chamber 45. A drive 424 preferably serves to electromotively move the dispensing means 42, in this case the screw conveyor 421. Between the second receiving chamber 45 and the first bowl-shaped section 411 in the impact chamber 2, the dispensing channel 41 preferably includes a longitudinally axial section 412 and/or a transversely axial section 413 (not shown here). If material fractions 52 of the second type fall out of the dispensing means 42 and remain in the longitudinally axial section 412 of the dispensing channel 41, it has proven effective to, as shown here, dispose a movable rake 43 between the dispensing means 42 and the second receiving chamber 45, in particular in the longitudinally axial 412 section of the dispensing channel 41, for the portioned dispensing of material fractions 52 of the second type into the second receiving chamber 45.

In particular dust-like material fractions 53 of a third type, which have been transported more easily than material fractions of the first 51 and the second 52 type and which have been transported to the dispensing device 4 with the aid of the circulating airflow LS in the same way as the material fractions 52 of the second type, can advantageously be separated from material fractions 52 of the second type with the aid of a suction device 462 for the supportive transport of material fractions 52 of the second type into the dispensing means 42, which is operatively connected with the base 416 of the bowl-shaped dispensing channel 41 opposite to the opening 414 to the impact chamber 2. A second separating screen 461 disposed in the base 416 of the bowl-shaped dispensing channel 41 opposite to the opening 414 to the impact chamber 2 can advantageously serve to separate material fractions 53 of a third type into a third receiving chamber 46. The dispensing means 42 is also preferably disposed and configured relative to the second separating screen 461 in such a way that material fractions 52 of the second type adhering to the second separating screen 461 can be removed by the dispensing means 42 during dispensing.

FIG. 4 shows a section of a second embodiment of the device 1 according to the invention with a dispensing means 42 configured as a spiral conveyor 422. In this example, means 415 for completely or partially reversibly closing the opening 414 can be seen in the region near the upper cover plate 23. The means 415 for completely or partially reversibly closing the opening 414 can, for example, be configured as retractable and extendable plates disposed in the region near the upper cover plate 23 of the impact chamber 2. On the one hand, they serve to protect the dispensing means 42 from material fraction 51 of the first type that is flung up and, on the other hand, they can also advantageously be used to regulate the material flow of the other material fractions 52, 53 into the dispensing channel 41.

FIG. 5 lastly shows a section through a third embodiment of a device 1 according to the invention with a dispensing means 42 configured as a cellular wheel 423 and functioning as a cellular wheel sluice. It can be seen that, in the case of a dispensing means 42 configured as a cellular wheel 423, the dispensing direction AR is perpendicular to the axis of the dispensing channel 41. Correspondingly, between the second receiving chamber 45 and the first bowl-shaped section 411 in the impact chamber 2, the dispensing channel 41 in this embodiment can advantageously include a transversely axial, preferably polygonal, section 413, in which the cellular wheel 423 ends. Material fractions, in particular of the second type 52, which have been taken up with the aid of the cellular wheel 423 that preferably projects into the impact chamber 2 and dispensed into the second receiving chamber 45, can then advantageously be removed from the device 1 with a movable rake, a belt conveyor and/or a chute.

The present invention advantageously allows individual material fractions 51, 52, 53 of a material composite 5, preferably a material fraction 52 of a second type that should at least be comminuted and preferably also has a lower density than a first material fraction 51, to be received from a region near an upper cover plate 23 and separated from the remaining material largely without further comminution, i.e. in relatively large pieces. This can be advantageous within a reclamation process of recyclable material, in particular if this can facilitate transport and further processing of individual material fractions 51, 52, 53.

In a further embodiment of a device 1 according to the invention, alternatively or in combination with the arrangement in the region of the upper cover plate 23, the dispensing opening 4 can also be arranged above the first separating screen 441 in the side wall 22. The material fraction 52 of the second type can therefore be dispensed from the impact chamber 2 at an early stage, for example in an upward movement toward the upper cover plate 23 along the side wall 22.

### LIST OF REFERENCE SIGNS P1552:

1 Device
11 Feed channel

2 Impact chamber
21 Base plate
22 Side wall
23 Cover plate

3 Striking tool
31 Striking element
32 Electric motor

4 Dispensing device
41 Dispensing channel
   411 Section (bowl-shaped)
   412 Section (longitudinally axial, tubular)
   413 Section (transversely axial, polygonal)
   414 Opening
   415 Means (for closing 41)
   416 Base
42 Dispensing means
   421 Screw conveyor
   422 Spiral conveyor
   423 Cellular wheel
   424 Drive
43 Rake
44 Receiving chamber (first)
   441 Separating screen (first)
   442 Conveying means
45 Receiving chamber (second)
46 Receiving chamber third
   461 Separating screen (third)
   462 Suction device
47 Feed nozzle
   471 Control valve

5 Material composite
51 Material fractions (of a first type)
52 Material fractions (of a second type)
53 Material fractions (of a third type)

ALS Dispensing airflow

AR Dispensing direction

LS Cyclic airflow

1. A device at least for separating material composites to be disposed of comprising at least two types of material fractions which differ with respect to their material properties, the device comprising:
an impact chamber for mechanical comminution, splitting and/or separation of the material composite to be disposed of into at least two types of material fractions, comprising
a base plate, at least one side wall and an upper cover plate,
a striking tool, which rotates in the impact chamber and comprises striking elements,
a feed channel for delivering the material composite to be disposed of to the striking tool,
wherein at least one first separating screen for separating material fractions of a first type into a first receiving chamber is disposed in the base plate and/or the side wall,
wherein at least one dispensing device for dispensing material fractions of a second type to a second receiving chamber is disposed above the first separating screen; and
wherein
at least in sections, the dispensing device in the region above the first separating screen and/or the upper cover plate includes
a dispensing channel configured with at least one opening facing toward the impact chamber and
a dispenser, which is disposed in the dispensing channel
and is configured to receive material fractions of the second type, from the region of the impact chamber above the first separating screen and/or near the upper cover plate.

2. The device according to claim 1, wherein the dispenser disposed in the dispensing channel is configured as a screw conveyor, as a spiral conveyor and/or as a cellular wheel.

3. The device according to claim 1, wherein between the second receiving chamber and the first bowl-shaped section in the impact chamber, the dispensing channel includes a longitudinally axial section and/or a transversely axial section.

4. The device according to claim 1, further comprising a closure configured to completely or partially reversibly close the opening.

5. The device according to claim 2, wherein a dispenser configured as a screw conveyor or as a spiral conveyor ends in a longitudinally axial section of the dispensing channel.

6. The device according to claim 1, wherein a movable rake for the portioned dispensing of material fractions of the second type into the second receiving chamber is disposed between the dispenser and the second receiving chamber.

7. The device according to claim 1, wherein feed nozzles for delivering fresh air to transport material fractions of the second type across the striking tool are disposed adjacent to the first separating screens.

8. The device according to claim 1, wherein feed nozzles for delivering fresh air, for transporting material fractions of the second type to the upper cover plate, toward the dispensing device, are disposed in the side wall.

9. The device according to claim 1, wherein the base of the bowl-shaped dispensing channel adjacent or opposite to the opening to the impact chamber is operatively connected with a suction device, for the supportive transport of material fractions of the second type into the dispenser.

10. The device according to claim 1, wherein a second separating screen for separating material fractions of a third type into a third receiving chamber is disposed in the base of a bowl-shaped dispensing channel opposite or adjacent to the opening to the impact chamber.

11. The device according to claim 10, wherein the dispenser is configured and disposed relative to the second separating screen in such a way that material fractions adhering to the second separating screen are removed or comminuted by the dispenser during dispensing.

12. A method for separating material composites to be disposed of comprising at least two types of material fractions which differ with respect to their material properties, comprising
comminuting and/or splitting a material composite to be disposed of, which comprises at least two types of material fractions having different material properties,
into material fractions of different types by interaction with striking elements of a striking tool and/or by interaction with at least one side wall of an impact chamber;
generating a circulating airflow in the impact chamber by a movement of the striking tool and/or by an injection of fresh air via feed nozzles;
separating the types of material fractions within the impact chamber into at least one material fraction of a first type and at least one material fraction of a second type by the circulating airflow in the impact chamber;
feeding the material fraction of the first type into a first receiving chamber via at least one first separating screen disposed in a base plate and/or a side wall of the impact chamber;
transporting the material fraction of the second type to a dispensing device at least partially by the circulating airflow; and
receiving, by a dispenser of the dispensing device, the material fraction of the second type from the region of the impact chamber above the first separating screen and/or near an upper cover plate and dispensing the material fraction of the second type from the device through a dispensing channel.

13. The method according to claim 12, wherein the material fraction of the second type is transported to the dispenser of the dispensing device at least partially by a dispensing airflow, which is generated by a suction device that is operatively connected to a base of the bowl-shaped dispensing channel opposite or adjacent to the opening to the impact chamber.

14. The method according to claim 12, wherein
separating, by a second separating screen
disposed in the base of the bowl-shaped dispensing channel opposite to the opening to the impact chamber,
a material fraction of the third type is from the material fractions of the first and/or second type, and
suctioning the material fraction of the third type out of the device with a dispensing airflow of a suction device that is operatively connected with a base of the bowl-shaped dispensing channel opposite or adjacent to the opening to the impact chamber.

15. The method of claim 14, wherein the material fraction of the third type is in the form of dust.

16. The device according to claim 6, wherein the movable rake is disposed between longitudinally axial or transversely axial sections of the dispensing channel.

17. The device according to claim 2, wherein a dispenser configured as a cellular wheel ends in a transversely axial section of said dispensing channel.

18. The device according to claim 17, wherein the transversely axial section is polygonal.

19. The device according to claim 5, wherein the longitudinally axial section is tubular.
